(19) United States
(12) Patent Application Publication
(10) Pub. No.: US 2026/0138258 A1
(43) Pub. Date: May 21, 2026

(54) KNIFE WITH INTEGRATED SHARPENER

(71) Applicant: Josiah Polhemus, Inglewood, CA (US)

(72) Inventor: Josiah Polhemus, Inglewood, CA (US)

(21) Appl. No.: 19/391,567

(22) Filed: Nov. 17, 2025

Related U.S. Application Data
(60) Provisional application No. 63/787,889, filed on Jan. 1, 0001.
(60) Provisional application No. 63/721,825, filed on Nov. 18, 2024.

(51) Int. Cl. B25G 1/08; B24D 15/08; B26B 3/00

(52) U.S. Cl. CPC B25G 1/08; B24D 15/084; B26B 3/00

(57) ABSTRACT

A knife is disclosed. The knife includes a handle, and a blade coupled to the handle. The knife also includes a sharpening apparatus within the handle. The sharpening apparatus can be removably coupled to the handle of the knife.

### CROSS-REFERENCE TO RELATED APPLICATIONS

This application is a non-provisional of and claims the benefit of U.S. Provisional Application No. 63/787,889, filed on Apr. 12, 2025, and U.S. Provisional Application No. 63/721,825, filed on Nov. 18, 2024, which are herein incorporated by reference in their entirety for all purposes.

### BACKGROUND

Knives have been around for a long time and are useful tools. They are always the most useful when they are sharp, and for that reason people are always finding ways to keep their knives' edges sharp.

Many sharpening tools have been made and tested. Most of them work well, yet can be cumbersome and time-consuming. Some issues relating to use of such sharpening tools are convenience and ease of use. Further, even if a user has a knife sharpener, they can lose or misplace it. This is a problem if the user needs to use the knife to cut something. Moreover, knife sharpening is an often neglected practice, and many people do not know how to sharpen their knives.

Embodiments of the invention address these and other problems, individually and collectively.

### SUMMARY

Embodiments of the technology provide for a convenient solution by detachably integrating a sharpening apparatus with a handle of a knife. By doing so, the sharpening apparatus is readily and regularly accessible to a user of the knife, and is user friendly. In some embodiments, the sharpening apparatus can be specifically designed for a handle of a knife.

One embodiment of the invention includes a knife comprising: a handle; a blade attached to the handle; and a sharpening apparatus detachably coupled to the handle.

Another embodiment of the invention includes a method of using a knife comprising a handle, a blade attached to the handle; and a sharpening apparatus detachably coupled to handle. The method comprises holding the knife, separating the sharpening apparatus from the handle, and sharpening the blade with the sharpening apparatus.

Another embodiment of the invention includes a method of making a knife. The knife comprises a handle, a blade attached to the handle; and a sharpening apparatus detachably coupled to the handle. The method comprises obtaining a sharpening apparatus, and detachably coupling to the handle.

These and other embodiments of the invention are described in further detail below.

### BRIEF DESCRIPTION OF THE DRAWINGS

FIG. 1 shows a knife according to an embodiment of the invention.

FIG. 2 shows an exploded view of a knife according to an embodiment of the invention.

FIG. 3 shows a view of a sharpening apparatus separated from a handle of the knife.

FIG. 4 shows a side view of a sharpening wheel assembly according to an embodiment.

FIG. 5 shows a view of a sharpening apparatus where a sharpening wheel assembly is exposed through slots in a sharpening apparatus housing according to an embodiment.

FIG. 6 shows an exploded view of a push to close latch assembly according to an embodiment.

FIG. 7 shows a latching and unlatching process for connecting a sharpening apparatus to a handle according to a first step according to a first embodiment.

FIG. 8 shows the latching and unlatching process for connecting a sharpening apparatus to a handle according to a second step according to a first embodiment.

FIG. 9 shows the latching and unlatching process for connecting a sharpening apparatus to a handle according to a third step according to a first embodiment.

FIG. 10 shows the latching and unlatching process for connecting a sharpening apparatus to a handle according to a fourth step according to a first embodiment.

FIG. 11 shows the latching and unlatching process for connecting a sharpening apparatus to a handle according to a fifth step according to a first embodiment.

FIG. 12 shows the latching and unlatching process for connecting a sharpening apparatus to a handle according to a sixth step according to a first embodiment.

FIG. 13 shows an exploded view of a knife according to another embodiment of the invention.

FIG. 14 shows an exploded view of some components of a push to close latch assembly of the knife shown in FIG. 13.

FIG. 15 shows a first step in a latching and unlatching process according to a second embodiment.

FIG. 16 shows a second step in the latching and unlatching process according to the second embodiment

FIG. 17 shows a third step in the latching and unlatching process according to the second embodiment

FIG. 18 shows a fourth step in the latching and unlatching process according to the second embodiment

FIG. 19 shows a fifth step in the latching and unlatching process according to the second embodiment

FIG. 20 shows a sixth step in the latching and unlatching process according to the second embodiment.

FIG. 21A shows an inner perspective view of a top base according to an embodiment.

FIG. 21B shows a cross-sectional view of the top base according to an embodiment.

FIG. 22A shows an inner perspective view of a bottom base according to an embodiment.

FIG. 22B shows a cross-sectional view of the bottom base according to an embodiment.

FIG. 23 shows a shape of an end of a plunger according to an embodiment.

FIG. 24 shows a top view of a knife blade of a knife being sharpened using a sharpening apparatus that uses magnets to detachably couple to a handle of the knife, according to an embodiment.

FIG. 25 shows a view of the knife and a sharpening apparatus that uses magnets, the sharpening apparatus has two housing portions which allow a user to access a sharpening element, according to an embodiment.

### DETAILED DESCRIPTION

Embodiments of the invention can include a knife with a sharpening apparatus which can reside within a handle of the knife when the sharpening apparatus is not in use. The sharpening apparatus can slide completely out of the handle when it will be used to sharpen the blade of the knife. In some embodiments, the sharpening apparatus can be secured inside a hollowed out portion of the handle of the knife using a spring-loaded push-to-open/push-to-close locking mechanism.

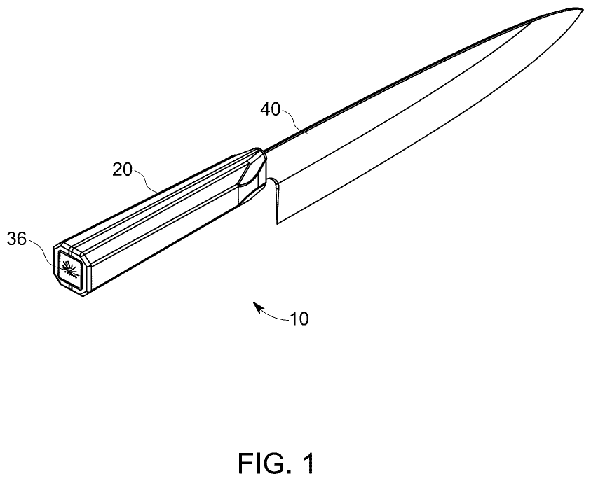

FIG. 1 shows a knife 10 comprising a handle 20 with a blade 40 (e.g., a metallic blade) attached to the handle 20. The handle 20 may be gripped by a user. A detachable sharpening apparatus 36 is removably disposed within the handle 20. In some embodiments, an end of the sharpening apparatus 36 and an end of the handle 20 are co-planar. In other embodiments, the sharpening apparatus 36 can be attached to an end of the handle 20 and can resemble part of the handle. In other embodiments, the sharpening apparatus can resemble the handle and is attached to the blade.

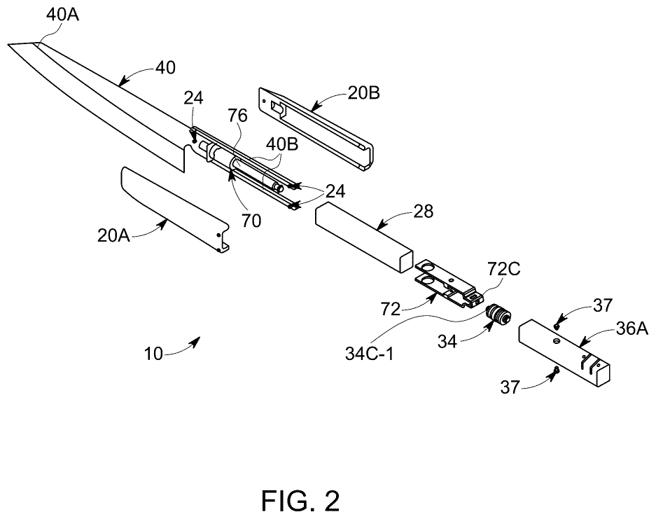

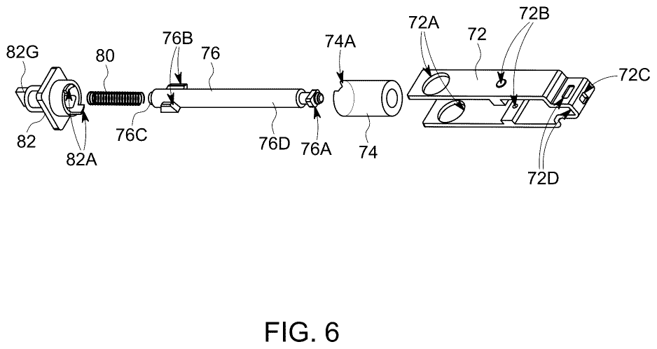

FIG. 2 shows an exploded view of a knife 10 according to a first embodiment of the invention. The detachable sharpening apparatus 36 in FIG. 1 may include a sharpening apparatus housing 36A. A holder 72 and a sharpening element in the form of a wheel assembly 34 can be within the sharpening apparatus housing 36A. Screws 37 can be used to secure the holder 72 in the sharpening apparatus housing 36A via holes in the sharpener apparatus housing 36A and the holder 72. The holder 72 can have a hole 72C that can receive an end structure 34C-1 of the wheel assembly 34, and is described in further detail below with respect to FIG. 6.

In some embodiments, the knife 10 includes a full split tang blade 40, which may be in the form of one continuous piece of metal from the tip of the knife 10 to the base of the handle. In this case, the blade 40 splits off where the cutting portion of the knife 10 ends and the handle 20 begins, thereby creating a wishbone-like shape. The split full tang defines an empty space that can receive the sharpening apparatus 36.

As shown in FIG. 2, the blade 40 can be a unitary structure, and can comprise a main blade portion 40A at a forward end. The blade 40 also includes two spaced apart tangs 40B which extend from the main blade portion 40A. The lengths of the tangs 40B can vary depending upon the side of the knife 10 and the blade 40, but are generally less than half of the length of the knife 10.

The handle 20 can include two hollowed handle portions 20A, 20B. In some embodiments, the handle portions 20A, 20B are identical. They can be assembled such that a plunger 76, a latch 70, the slot lining 28, and the blade tangs 40B are between the handle portions 20A, 20B and enclosed within the handle 20. Alignment pins 24 can be used to align the handle portions 20A, 20B so that they are aligned when they are assembled together. The handle portions 20A, 20B can be made of any suitable material including wood, hard plastic, and/or an epoxy infused material. In some embodiments, the outermost part of the handle portions 20A, 20B can be half-octagonal shaped or curved, thereby providing the user with a comfortable grip. The inner surfaces of the handle portions 20A, 20B are hollowed out sections define a slot for the push latch 70 and a rectangular slot for a slot lining 28.

The slot lining 28 can provide a transition between the handle 20 and the sharpening apparatus 36 inside of the handle 20. The slot lining 28 may be made of any suitable material including metal or plastic. The purpose of the slot lining 28 can be to ensure that the sharpening apparatus 36 can easily slide in and out of the handle 20. The slot lining 28 can also be wear resistant to protect the handle 20 that surrounds it. The slot lining 28 can be permanently or temporarily joined to the blade 40 of the knife 10 during assembly, providing the knife 10 with even more rigidity in the perpendicular axis.

In some embodiments a rectangular seal ring (not shown) can be attached to the bottom of the handle 20 of the knife 10 where the sharpening apparatus 36 enters the handle 20 of the knife 10. In this example, the slot lining 28 ends before the bottom of the handle 20, and can create a rectangular cavity where the seal ring is placed during assembly. This seal ring can keep moisture such as water and small contaminants from entering the inside of the handle 20 of the knife 10. The seal ring can also act as a friction fit for the sharpening apparatus 36, thus reducing the play created by the push latch 70.

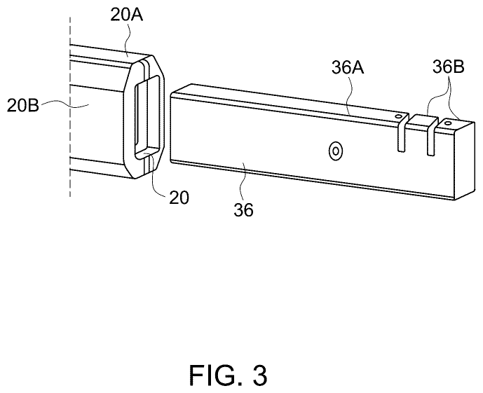

FIG. 3 shows a view of a sharpening apparatus 36 separated from the handle 20 of the knife 10. In some embodiments during regular use of the knife 10, the sharpening apparatus 36 is fully contained inside the handle 20 of the knife 10. This creates a flush surface on the base or “butt” of the handle 20. In other embodiments, the sharpening apparatus 36 can be attached to an end of the handle 20, or it may be partially inside of the handle 20. In other embodiments, the sharpening apparatus resembles the handle where the blade is partially inside the handle.

The sharpening apparatus 36 can be locked within the handle 20 unless it is unlocked by the user. If the sharpening apparatus 36 is to be used, the user pushes the exposed end of the sharpening apparatus 36 that is flush with the base of the knife 10 to activate the push latch 70 (in FIG. 2). The sharpening apparatus 36 can then slide out of the base of the knife 10, parallel to, but in the opposite direction as the forward portion of the blade 40. The sharpening apparatus 36 is restricted from lateral movement by the slot lining 28 (in FIG. 2) as it is ejected from and separates from the handle 20.

The sharpening apparatus housing 36A can include two angled slots 36B to expose a sharpening element inside of the sharpening apparatus housing 36A. In some embodiments, the sharpening element is a sharpening wheel assembly with two or more sharpening wheels consisting of different grits, including a coarse sharpening wheel and a fine sharpening wheel. The slots 36B can be sized so that the blade 40 can pass through them and be guided to contact the sharpening element. In some embodiments, the slots 36B can be numbered so that the user can follow a multi-step or two-step sharpening process that corresponds with first sharpening the blade 40 of the knife 10 with a course wheel of the sharpening element, and second sharpening the blade 40 of the knife 10 with a fine wheel of the sharpening element. The slots 36B can each be slightly wider than the thickness of the blade 40. Both slots 36B can be parallel and can be angled approximately 15 degrees away from a major axis perpendicular to sharpening apparatus 36. Although two slots 36B are shown, the sharpening apparatus may have any number of slots. The angled slots 36B provide access to the sharpening wheels 34A, 34B in the wheel assembly 34. The slots 36B are to guide the blade in the correct angle while coming in contact with the wheel assembly 34 during the sharpening process.

In some embodiments, the sharpening apparatus need not have any slots. For example, a sharpening element such as a sharpening wheel assembly could be within the sharpening apparatus housing 36A. A user could remove the sharpening element from the sharpening apparatus housing 36A and use it to sharpen the blade of the knife.

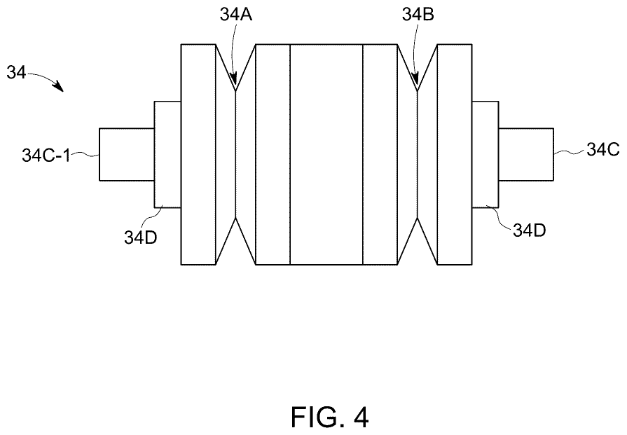

FIG. 4 shows a side view of a sharpening wheel assembly 34 according to an embodiment, which can be an example of a sharpening element. Other examples of sharpening elements include knife sharpening blocks that are not in the form of a wheel. In some embodiments, the sharpening wheel assembly 34 can be a dual grit wheel sharpener that has a single axis of rotation. In some embodiments, the dual grit wheel sharpener comprises multiple sharpening disks which can include at least one wheel 34A being of a lower (coarse) grit and at least one wheel 34B being a higher (fine) grit. The wheels 34A, 34B in the sharpening wheel assembly 34 can be made with an abrasive material comprising an alumina ceramic or diamond/CBN coated metal. The wheels 34A, 34B can be assembled together creating two V-shaped valleys as shown in FIG. 4. The wheels 34A, 34B can be held together using a rod 34C that passes through center holes in the wheels 34A, 34B. The rod 34C can have an end structure 34C-1 which can be received by a hole (72C in FIG. 2) in an end of the previously described holder. The wheels 34A, 34B can be secured on the rod with two caps 34D.

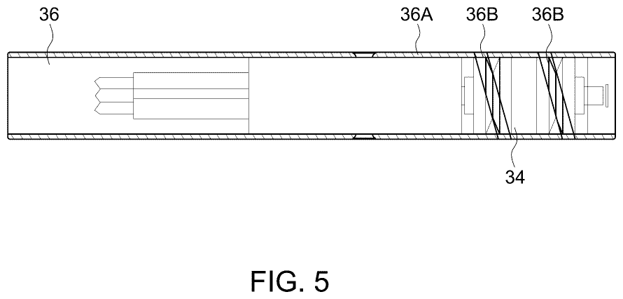

FIG. 5 shows a view of a sharpening apparatus 36 with sharpening apparatus housing 36A and wheel assembly 34 within it. The angled slots 36B are shown and they provide access to the sharpening wheels 34A, 34B in the wheel assembly 34.

FIG. 6 shows an exploded view of a rotationally locking push to open/push to close latch assembly according to an embodiment. In some embodiments, the rotationally locking push to open/push to close latch assembly holds the sharpening apparatus 36 at least partially inside the handle 20 of the knife 10. The latch assembly can include the five components that are illustrated in FIG. 6. They include a bottom base 82 and a top base 74. A plunger 76 and a spring 80 are between the bottom base 82 and the top base 74. The plunger 76 can have a plunger locking tab 76A at one end and an end structure 76C at the other end. The plunger 76 can also have opposing angled pins 76B on or formed in an elongated body 76D (e.g., an elongated cylindrical body) of the plunger 76.

The latch assembly can also include a holder 72. In some embodiments, the holder 72 has two spaced apart, parallel portions connected by an integral end portion, thereby forming a reverse C-shape. The holder 72 can receive the top base 74, the plunger 76, the spring 80 and at least a portion of the bottom base 82. The holder 72 can be connected to the inside of the sharpening apparatus housing 36A with removable screws, which engage screw holes 72B so that the sharpening element (not shown) can be replaced after repeated use. The rest of the components can be permanently assembled inside the knife's handle, with the plunger 76 and the spring 80 being the only free-moving parts. The holder 72 can also have disassembly cutouts 72A and the screw holes 72B in the two parallel portions. The connecting end portion of the holder 72 can have locking slots 72D and a hole 72C to receive an end of the sharpening element.

In some embodiments, to assemble the latch, the plunger 76 is inserted into the top base 74, such that a portion of it passes through a central aperture in the top base 74. The spring 80 can be inserted into the bottom base 82, and interfaces with an end portion of the plunger 76. The bottom base 82 is then secured to the top base 74, creating an enclosure for the plunger 76 and the spring 80. The bottom base 82 can have two alignment tabs 82A that slide into two alignment slots 74A in the top base 74. This orients the top base 74 with the bottom base 82. The bottom base 82 also has a cylindrical slot for the spring 80 to be correctly positioned. The other side of the bottom base 82 has an alignment tab 82G that can be used to align the latch assembly.

The function of the latch assembly according to a first embodiment can be described with reference to FIGS. 1-12.

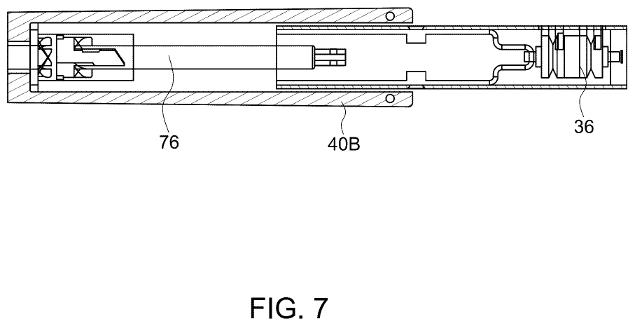

FIG. 7 shows a latching and unlatching process for connecting a sharpening apparatus 36 to a handle 20 according to a first step. As shown, the sharpening apparatus 36 is free to slide out of the handle 20 of the knife 10. At this point, the sharpening apparatus 36 is not mechanically coupled to the plunger 76, which is attached to the inside of the handle 20.

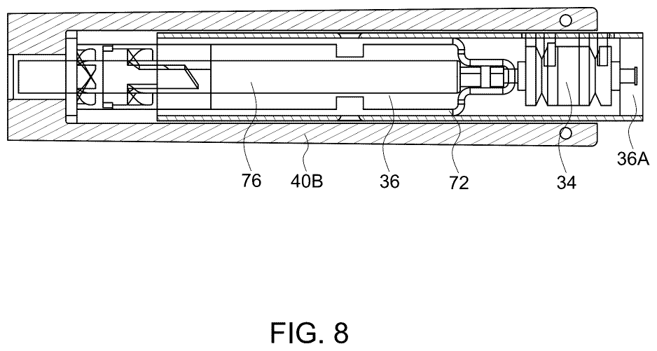

FIG. 8 shows a latching and unlatching process for connecting the sharpening apparatus 36 to the handle 20 according to a second step. In some embodiments the latch begins to operate when the wheel assembly 34 comes in contact with the plunger 76. The plunger 76 is able to contact the wheel assembly 34 because of a hole 72C at an end of the holder 72. The plunger 76 first pushes the wheel assembly 34 into the sharpener apparatus housing 36A without allowing any side to side play with respect to the wheel assembly 34. The locking tab 76A of the plunger 76 also aligns with (e.g., are in the same plane, but not yet engaged) the locking slots 72D (see FIG. 6) of the holder 72.

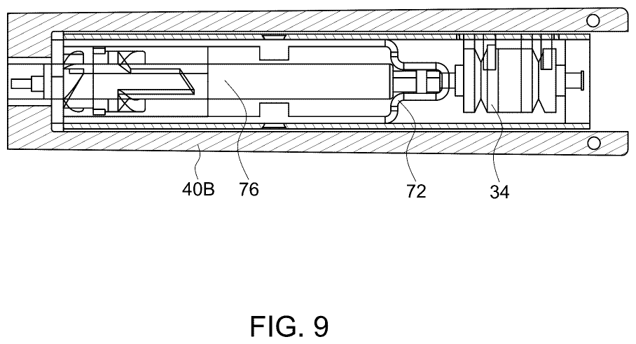

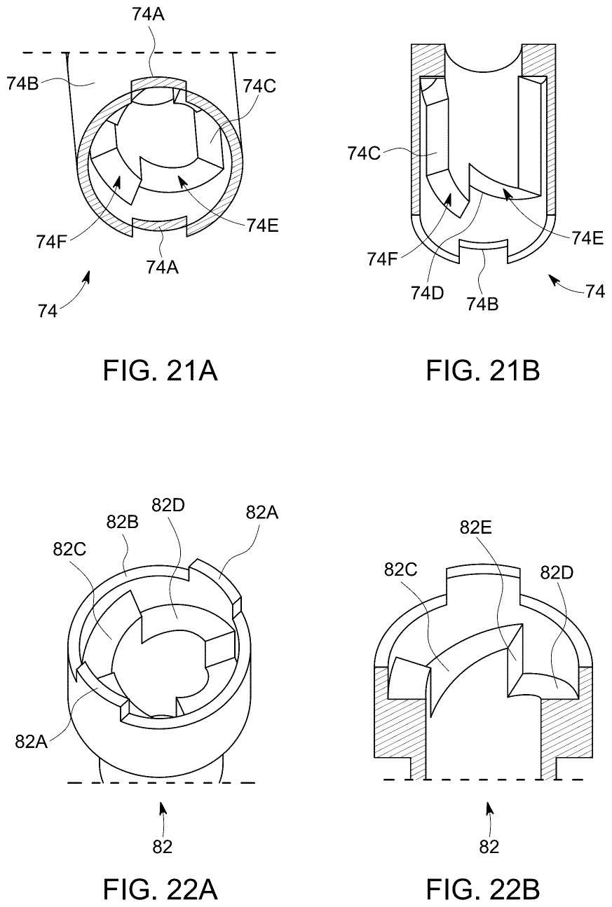

FIG. 9 shows a latching and unlatching process for connecting the sharpening apparatus 36 to the handle 20 according to a third step. In some embodiments, the plunger 76 is pushed far enough into the handle 20 so that it leaves the guided slots (e.g., unlocked state feature 74C in FIG. 21B) of the top base 74 and allows for the angled pins 76B of the plunger 76 to come in contact with sloped surfaces (e.g., sloped surface 82C in FIGS. 22A and 22B) of the bottom base 82. The plunger 76 continues to be pushed and begins to rotate until coming to a stop because of the sloped surface in the bottom base 82. The locking tab 76A of the plunger 76 is now engaged with the locking slots 72D of the holder 72. The sharpening apparatus 36 is now secured to the handle 20 until the user takes further action to separate it from the handle 20.

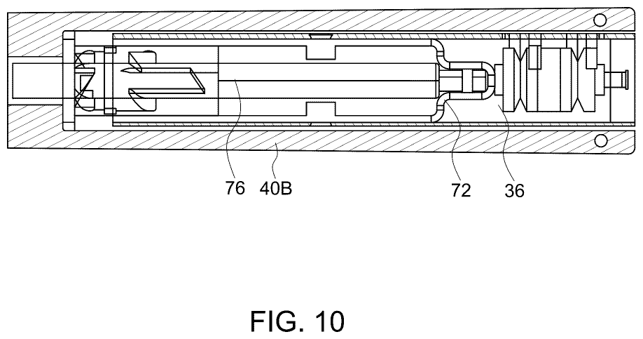

FIG. 10 shows a latching and unlatching process for connecting the sharpening apparatus 36 to a handle 20 according to a fourth step. In some embodiments, the spring 80 pushes the plunger 76 in the opposite direction. The plunger 76 has rotated slightly and now the angled pins 76B of the plunger 76 come into contact with the sloped surface in the top base 74 (e.g., see sloped surface 72F in FIGS. 21A and 21B). The spring 80 continues to push the plunger up the sloped surface of the top base 74 and it rotates until the angled alignment pins 76B of the plunger 76 are locked into a feature on the top base 74 (e.g., a locked state feature 74D in FIG. 21B). At this point, the plunger 76 has rotated 90 degrees. This rotation locks the plunger locking tabs 76A into the locking slots 72D on the lock. The latch assembly is now in a compressed (e.g., the spring 80 is compressed) and locked state.

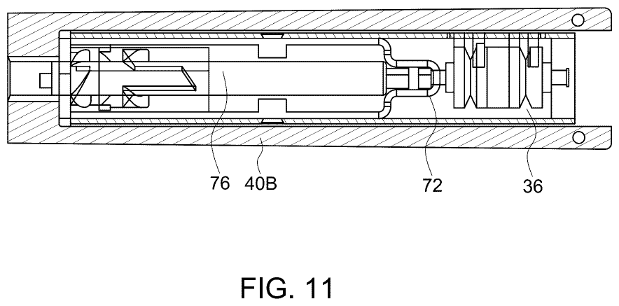

FIG. 11 shows a latching and unlatching process for connecting a sharpening apparatus 36 to a handle according to a fifth step. In some embodiments, to unlock the sharpening apparatus 36 to allow the sharpening apparatus 36 to separate from the handle 20, the sharpening apparatus 36 is pushed inward again to push the plunger 76 into the bottom base 82. The plunger 76 is pushed far enough that it leaves the locking feature of the top base 74 (e.g., 74D in FIG. 21B) and allows for the angled pins 76B of the plunger 76 to again come in contact with the sloped surface of the bottom base 82 (e.g., 82C or 82D in FIGS. 22A and 22B). The plunger 76 continues to be pushed and begins to rotate until coming to a stop because of the sloped surface in the bottom base 82.

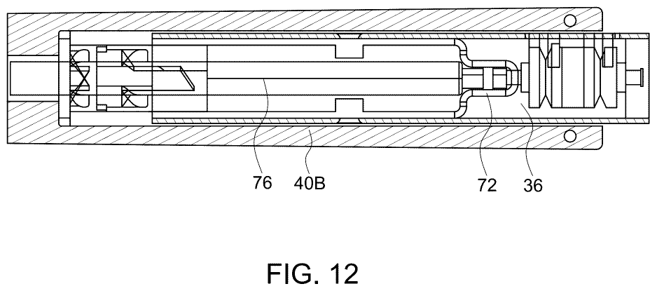

FIG. 12 shows a latching and unlatching process for connecting a sharpening apparatus 36 to the handle 20 (see FIG. 1) according to a sixth step. In some embodiments, the spring 80 pushes the plunger in the opposite direction. The plunger 76 has rotated slightly and now the angled pins 76B of the plunger 76 come into contact with the sloped surface in the top base 74 (e.g., 74F in FIGS. 21A and 21B). The spring 80 continues to push the plunger 76 up the sloped surface of the top base 74, and it rotates until the angled pins 76B of the plunger 76 get locked into the original deeper slot on the top base 74 (e.g., unlocked state feature 74C in FIGS. 21A and 21B). At this point, the plunger 76 has again rotated 90 degrees. This rotation unlocks the plunger locking tabs 76A from the locking slots 72D of the holder 72 on the lock. The latch is now in the elongated and unlocked position, allowing the sharpening apparatus 36 to fully slide out of the handle 20. FIG. 12 shows the plunger 76, the holder 72, and the sharpening apparatus between blade tangs 40D.

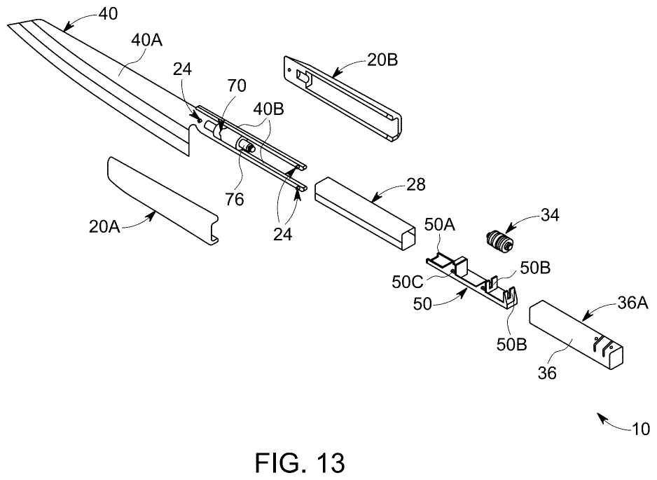

FIG. 13 shows an exploded view showing components of a knife 10 according to another embodiment of the invention. The knife 10 includes a metallic blade 40 and a handle 20, which may be gripped by a user. A detachable sharpening apparatus 36 can be disposed within the handle 20 and may include a sharpening apparatus housing 36A and a holder 50 and a wheel assembly 34 within the sharpening apparatus housing 36A.

In some embodiments, the knife 10 includes a full split tang blade 40, which may be in the form of one continuous piece of metal from the tip of the knife 10 to the base of the handle. In this case, the blade 40 splits off where the cutting portion of the knife 10 ends and the handle 20 begins, thereby creating a wishbone-like shape. The split full tang defines an empty space that can receive the sharpening apparatus 36.

The blade 40 can be a unitary structure, and can comprise a main blade portion 40A at a forward end. The blade 40 also includes two spaced apart tangs 40B which extend from the main blade portion 40A. The lengths of the tangs 40B can vary depending upon the size of the knife 10 and the blade 40, but they are generally less than half of the length of the knife 10.

The handle 20 can include two hollowed handle portions 20A, 20B. In some embodiments, the handle portions 20A, 20B are identical. They can be assembled such that a plunger 76, a latch 70, the slot lining 28, and the blade tangs 40B are between the handle portions 20A, 20B and are enclosed within the handle 20. Alignment pins 24 can be used to align the handle portions 20A, 20B so that they are aligned when they are assembled together. The handle portions 20A, 20B can be made of any suitable material including wood, hard plastic, and/or an epoxy infused material. The outermost part of the handle portions 20A, 20B can be half-octagonal shaped or curved, thereby providing the user with a comfortable grip. The inner surfaces of the handle portions 20A, 20B are hollowed out sections define a slot for the push latch 70 and a rectangular slot for a slot lining 28.

The slot lining 28 can provide a transition between the handle 20 and the sharpening apparatus 36 inside of the handle 20. The slot lining 28 may be made of any suitable material including metal or plastic. One use of the slot lining 28 can be to ensure that the sharpening apparatus 36 can easily slide in and out of the handle 20. The slot lining 28 can also be wear resistant to protect the handle 20 that surrounds it. The slot lining 28 can be permanently or temporarily joined to the blade 40 of the knife 10 during assembly. It provides the knife 10 with even more rigidity in the perpendicular axis.

In some embodiments a rectangular seal ring (not shown) can be attached to the bottom of the handle 20 of the knife 10 where the sharpening apparatus 36 enters the handle 20 of the knife 10. The slot lining 28 ends before the bottom of the handle 20, and can create a rectangular cavity where the seal ring is placed during assembly. This seal ring can keep moisture such as water and small contaminants from entering the inside of the handle 20 of the knife 10. The seal ring can also act as a friction fit for the sharpening apparatus 36, thus reducing the play created by the push latch 70.

The holder 50 in FIG. 13 is different from the holder 72 in FIG. 2. The holder 50 in FIG. 13 has an elongated portion 50A with two stands 50B with slots to receive ends of the wheel assembly 34 (or other sharpening element). The stands 50B and a latch lock portion 50C extend vertically upward from an elongated portion 50A. The latch lock portion 50C includes a locking slot 50D, which can receive a locking tab of the plunger 76.

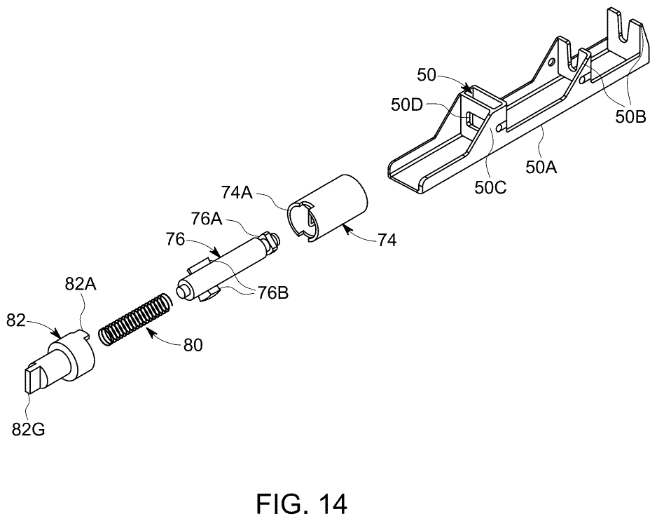

FIG. 14 shows an exploded view of some components of the knife 10 shown in FIG. 13.

In some embodiments, the rotationally push locking and unlocking assembly holds the sharpening apparatus 36 inside of the handle 20 of the knife 10. The push locking and unlocking assembly can include a bottom base 82, a top base 74, a plunger 76, a spring 80, and a holder 50. The holder 50 can be connected to the sharpening apparatus 36 during assembly. The holder 50 can have a removable lid (sharpener house top) so that the wheel assembly 34 can be accessed and replaced after numerous uses. The rest of the components can be assembled inside the handle 20 of the knife 10. The plunger 76 and the spring 80 can be free moving parts, while the other parts can be stationary when the sharpening assembly is connected and disconnected from the knife 10.

In some embodiments, to assemble the latch, the plunger 76 is inserted into a central aperture in the top base 74 such that a portion of the plunger 76 extends through the top base 74. The spring 80 is inserted into the bottom base 82. The bottom base 82 also has a cylindrical slot for the spring 80 to be correctly positioned. The bottom base 82 is then secured to the top base 74, creating an enclosure for the plunger 76 and the spring 80. The bottom base 82 has two tabs 82A that slide into two alignment slots 74A of the top base 74 for correct orientation during assembly. On the other side of the bottom base 82 is a tab 82G that can be used as an alignment mechanism to ensure that the latch assembly is correctly oriented.

The function of the latch in a second embodiment can be described with reference to FIGS. 13-20.

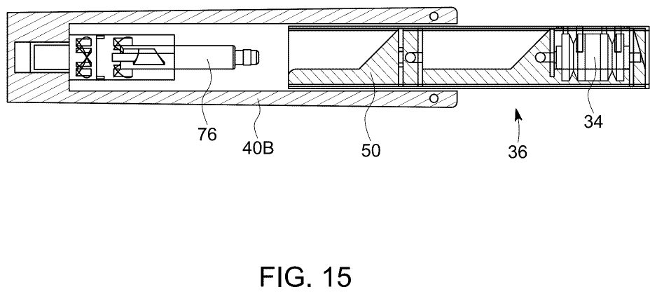

FIG. 15 shows a first step in a latching and unlatching process according to the second embodiment. In the first step, In some embodiments the sharpening apparatus 36 is free to slide out of the handle. The plunger 76 is spaced and separated from the sharpening apparatus 36. The sharpening apparatus 36 has the wheel assembly 34 and the holder 50. The plunger 76, and the sharpening apparatus 36 are between blade tangs 40B.

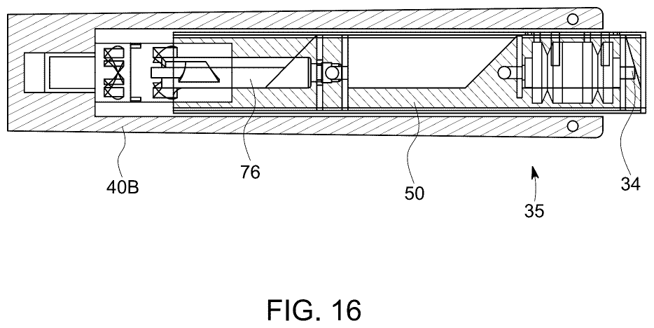

FIG. 16 shows a second step in a latching and unlatching process according to the second embodiment. In the second step, the latch begins to operate when the holder 50 comes in contact with the plunger 76. At this point, the locking tab of the plunger 76 also aligns with (e.g., are in the same plane, but not yet engaged) the locking slot (e.g., 50D in FIG. 14) of the holder 50.

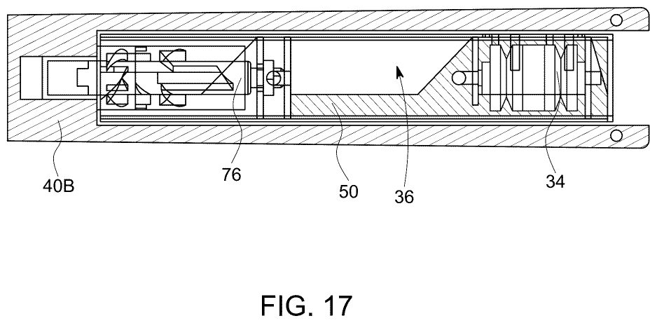

FIG. 17 shows a third step in a latching and unlatching process according to the second embodiment. In a third step, once the sharpening apparatus 36 is pushed far enough into the handle 20 (see FIG. 1) so that the plunger 76 leaves the guided slots (e.g., unlocked state feature 74C in FIG. 21B) of the top base 52 and allows for the angled pins 76B of the plunger 76 to come in contact with the sloped surfaces (e.g., sloped surface 82C in FIGS. 22A and 22B) of the bottom base 82. The plunger 76 continues to be pushed and begins to rotate until coming to a stop because of the wall 82E on the bottom base 82 shown in FIG. 22B. The locking tab 76A of the plunger 76 is now engaged with the locking slot 50D of the holder 50. The sharpening apparatus 36 is now secured to the handle 20 until the user takes further action to separate it from the handle 20.

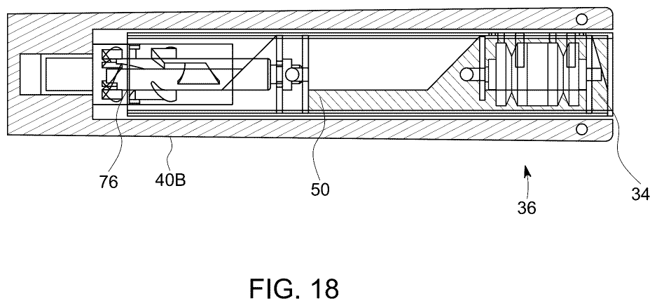

FIG. 18 shows a fourth step in the latching and unlatching process according to the second embodiment. In a fourth step, the spring 80 pushes the plunger 76 in the opposite direction. The plunger 76 has rotated slightly, and now the angled pins 76B of the plunger 76 come into contact with the sloped surface in the top base 74. The spring 80 continues to push the plunger 76 up the sloped surface of the top base 74 (e.g., see sloped surface 72F in FIGS. 21A and 21B). The plunger 76 rotates until the angled pins 76B of the plunger 76 are locked and immobilized in a feature on the top base 52 (e.g., a locked state feature 74D in FIG. 21B). At this point, the plunger 76 has rotated 90 degrees. This rotation locks the plunger 76 locking tabs into the locking slot 50D on the holder 50. The latch assembly is now in a compressed (e.g., the spring 80 is compressed) and locked state.

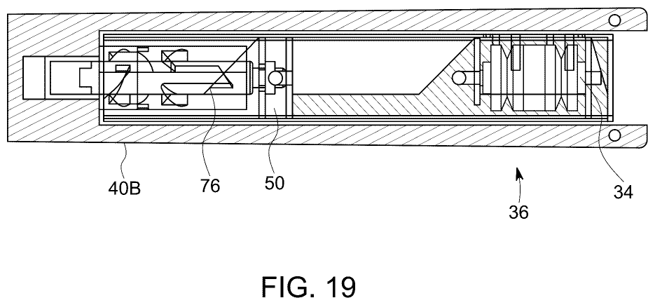

FIG. 19 shows a fifth step in a latching and unlatching process according to the second embodiment. In the fifth step, to unlock the sharpening apparatus 36 to separate from the handle, the sharpening apparatus 36 is pushed inward again to push the plunger 76 into the bottom base 82. The plunger 76 is pushed far enough that it leaves the locking feature of the top base 74 (e.g., 74D in FIG. 21B) and allows for the angled pins 76B of the plunger 76 to again come in contact with the sloped surface of the bottom base 82 (e.g., 82C or 82D in FIGS. 22A and 22B). The plunger 76 continues to be pushed and begins to rotate until coming to a stop because of the wall 82E on the bottom base 82 shown in FIG. 22B.

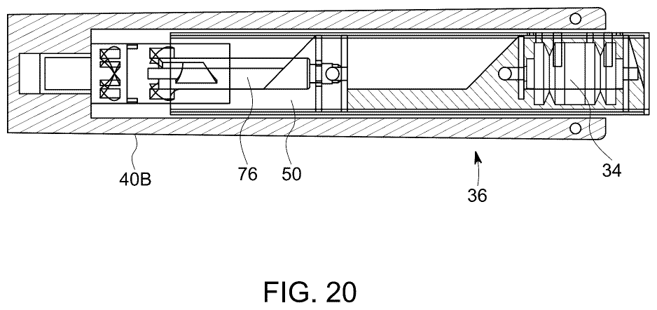

FIG. 20 shows a sixth step in the latching and unlatching process according to the second embodiment. In the sixth step, the spring 80 pushes the plunger 76 in the opposite direction. The plunger 76 has rotated slightly and now the angled pins 76B of the plunger 76 come into contact with the sloped surface in the top base 74 (e.g., 74F in FIGS. 21A and 21B). The spring 78 continues to push the plunger 76 up the sloped surface of the top base 74 and it rotates until the angled pins of the plunger 76 get locked into the original deeper slot on the top base 52 (e.g., unlocked state feature 74C in FIGS. 21A and 21B). At this point, the plunger 76 has again rotated 90 degrees. This rotation unlocks locking tabs 76A of the plunger 76 from the locking slot 50D on the holder 50. The latch is now in the elongated and unlocked position, allowing the sharpening apparatus 36 to fully slide out of the handle 20.

FIG. 21A shows an inner, bottom perspective view of a top base 74. FIG. 21B shows a cross-sectional view of the top base. The top base 74 includes a cylindrical body 74B with alignment slots 74A formed at an end of the top base 74. The top base 74 also includes a molded inner structure within the cylindrical body 74B. The inner structure can include an unlocked state feature 74C (e.g., a long slot) which receives an angled pin of the plunger when the plunger is in an unlocked state. The inner structure can also include a locked state feature 74D (e.g., an open region defined in part by a sloped surface, the open region being shorter than the above-described long slot) to receive the angled pins of the plunger when the plunger is in a locked state. The molded inner structure can comprise a first sloped surface 74E and a second sloped surface 74F, the first and second sloped surfaces 74E, 74F being at different rotational locations along the cylindrical axis of the top base 74. FIG. 21B is in a downward orientation such that the blade of the knife is pointing down, and the slopes of the sloped surfaces 74E, 74F gradually slope downward in a clockwise direction, while being at different axial positions.

FIG. 22A shows an inner perspective view of a bottom base 82. FIG. 22B shows a cross-sectional view of the bottom base 82. The bottom base 82 comprises alignment tabs 82A extending from an end of the cylindrical body 82B. The cylindrical body 82B also comprises a molded inner structure comprising a first sloped surface 82C and a second sloped surface 82D, the first and second sloped surfaces 82C, 82D being in different axial positions in the bottom base 82. As shown, the first and second sloped surfaces 82D, 82C can gradually slope upward in a clockwise direction when the orientation of the blade of the knife is down. The first sloped surface 82C can slope upward until the sloping abruptly stops at one end of a vertical wall 82E of the molded inner structure. The other end of the vertical wall 82E can define a start of the second sloped surface 82D as shown in FIG. 22B. In other embodiments, the features on the latch 70 components could be mirrored and the functionality of the latch would remain the same and yet simply rotate in the opposite direction.

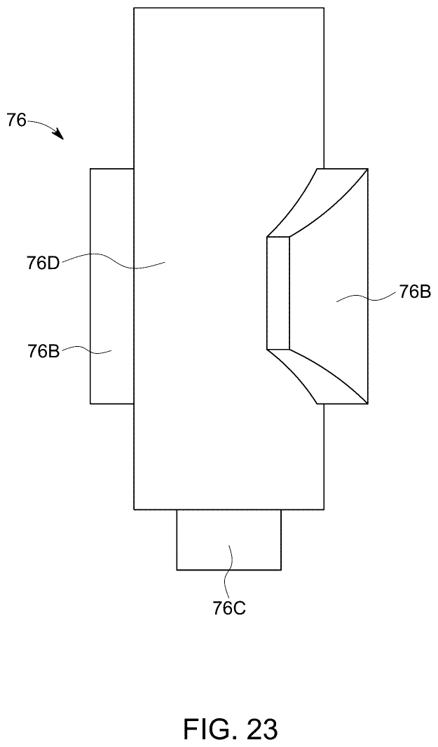

FIG. 23 shows a shape of an end of a plunger 76. The plunger 76 includes a cylindrical body 76D and spaced apart alignment pins 76B oriented on an outer surface of the cylindrical body 76D in an axial direction near an end of the plunger 76. Each alignment pin 76B can have a longer axial side and a shorter axial side. As shown in FIG. 23, top and bottom surfaces of an alignment pin 76B can slope from ends of the longer side to ends of the shorter side. The end of the plunger 76 has an end structure 76C, which can be received by the previously described spring.

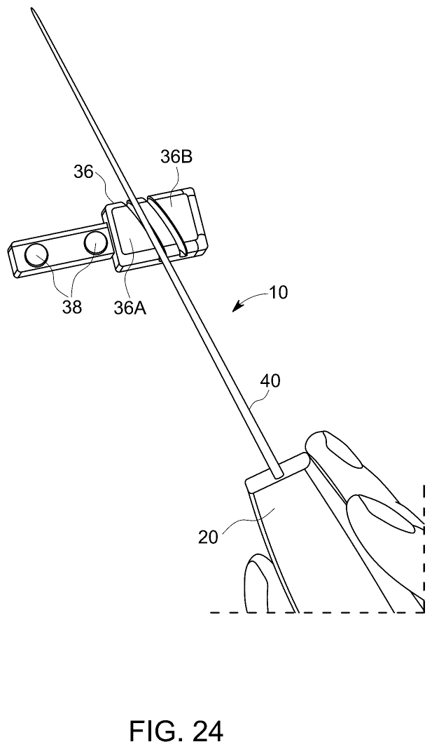

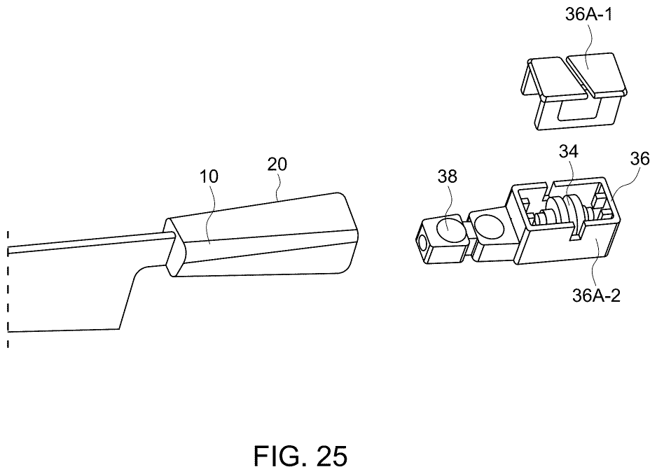

FIG. 24 shows a top view of a knife blade 40 of a knife being sharpened using a sharpening apparatus 36 that uses magnets 38 to detachably couple the sharpening apparatus 36 to a handle 20 of the knife 10. Similar to the previously described embodiments, the handle 20 can have a hollow area that can detachably receive the sharpening apparatus 36. However, in this embodiment, instead of a mechanical latch assembly, the magnets detachably couple the sharpening apparatus 36 to a handle 20 of the knife 10. Shown in FIG. 24 and FIG. 25, the sharpening apparatus 36 can have two magnets 38, which can magnetically couple to two corresponding magnets in the hollow area of the handle 20. The end of the handle 20 can be shaped with cutouts such that a user can use their fingers to pull the sharpening apparatus 36 and separate the sharpening apparatus 36 from the handle 20. In other embodiments, the inner end of the sharpening apparatus 36 can be designed to engage with a spring, which can allow a user to detachably couple the sharpening apparatus 36 by pushing the sharpening apparatus 36 inward. This can detach the sharpening apparatus 36 from the handle 20 and eject the sharpening apparatus 36 away from the handle 20 such that it can be separated from the handle 20.

Alternatively, as shown in FIG. 25, the housing of the sharpening apparatus 36 can have a larger portion which contains the wheel assembly 34 and a smaller portion which has the magnets 38. The larger portion has a cover 36A-1, which allows a user to access the wheel assembly 34 and replace it if needed. The smaller portion with the magnets 38 can be inserted into a cooperatively structured hollow area in the handle 20 of the knife 10. The surface of the hollow area can have corresponding magnets which allows the sharpening apparatus 36 to attach and detach to the handle 20. In this embodiment, a portion of the sharpening apparatus 36 lies outside of the handle 20, while another portion is inside of the handle 20. A user can grasp the portion of the sharpening apparatus 36 that is outside of the handle 20 to separate it from the handle 20.

One embodiment of the invention includes a method of using a knife comprising a handle, a blade coupled to the handle; and a sharpening apparatus within the handle. The method comprises holding the knife, separating the sharpening apparatus from the handle and sharpening the blade with the sharpening apparatus.

In some embodiments, the user can follow the following steps.

Set up:
1. Hold the knife in your dominant hand with the blade of the knife facing away.
2. With your free hand, push the only exposed face (located at the bottom of the handle) of the sharpener in until it stops.
3. Release the push motion, and watch the sharpening apparatus pop out.
4. Grab the sharpening apparatus with your free hand and place it on a flat surface.
5. Orient the sharpening apparatus so that the wheels are nearest your dominant hand.

Sharpening Process:
6. Firmly grasp the sharpener and secure it firmly to the flat surface.
7. Bring the edge of the knife in contact with the wheel located in the first slot.
8. Using slight pressure, slide the knife back and forth 10-20 times on the wheel using the first slot as a guide.
9. Repeat steps 7 and 8 for the consecutive slots.

Post Process:
10. Rinse and dry the blade.
11. Return the sharpener back into the bottom of the handle.
12. Slide/push the sharpener all the way in the handle until it stops.
13. Use the sharpened knife.

Another embodiment includes a method of making a knife comprising a handle, a blade coupled to the handle; and a sharpening apparatus within the handle, the method comprising: creating the sharpening apparatus; and inserting the sharpening apparatus into the handle. The method can also include obtaining a bottom base, a plunger, a spring, a plunger, a top base, a latch lock and holder, and a sharpening element as described above. The sharpening element can be attached to the latch lock and holder, and the sharpening element and the latch and lock holder can be inserted into a housing to form the sharpening apparatus. The method can also include assembling the top base and the bottom base such that the spring and at least a portion of the plunger are between the top base and the bottom base, and a portion of the plunger extends beyond the top base. The method can further include coupling hollowed handle portions of the handle and enclosing the assembled top base and bottom base in a hollowed area of the handle formed by the hollowed portions of the handle.

Embodiments of the invention have a number of advantages. In some embodiments, the technology of the knife with integrated wheel sharpener consists of a split blade tang, hollowed handle, slot lining, integrated sharpener, angled guide slots, rotationally locking push latch, and dual grit sharpening wheel. The integrated sharpening apparatus provides an effective and efficient way to sharpen a knife blade. The sharpening apparatus is fully self-contained and equipped with the necessary features to keep the blade of the knife sharp.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A knife comprising:
a handle;
a blade attached to the handle; and
a sharpening apparatus detachably coupled to the handle.

2. The knife of claim 1, wherein the blade comprises a blade portion and a tang coupled to the handle, the tang comprising two tang portions separated by a gap.

3. The knife of claim 2, wherein the sharpening apparatus is between the tang portions when the knife is in use.

4. The knife of claim 3, wherein the sharpening apparatus comprises a sharpening element and a sharpening apparatus housing comprising slots.

5. The knife of claim 1, wherein the sharpening apparatus is detachably attached to the handle via a magnet.

6. The knife of claim 1, further comprising:
a slot lining comprising an aperture, which is sized to receive the sharpening apparatus.

7. The knife of claim 1, further comprising:
a push locking and unlocking assembly adapted to allow the sharpening apparatus to be located within the handle and to be removed from the handle.

8. The knife of claim 7, wherein the push locking and unlocking assembly comprises a bottom base, a plunger, a spring between the bottom base and the plunger, a top base comprising an aperture that is configured to receive the plunger, and a holder.

9. The knife of claim 1, further comprising:
a push locking and unlocking assembly adapted to allow the sharpening apparatus to be located within the handle and to be removed from the handle, wherein the push locking and unlocking assembly comprises a bottom base, a plunger, a spring between the bottom base and the plunger, a top base comprising an aperture that is configured to receive the plunger, and a holder, the holder comprising an elongated portion and stands extending from the elongated portion, the stands configured to secure a sharpening element.

10. The knife of claim 9, wherein the holder further comprises a locking slot configured to receive a locking tab of the plunger.

11. The knife of claim 10, wherein the sharpening element can comprise sharpening tools of varying roughness.

12. The knife of claim 11, wherein the plunger comprises angled pins on a cylindrical body, the angled pins being spaced apart and figured to engage with sloped surfaces of inner molded structures of the top base and the bottom base.

13. The knife of claim 12, wherein the spring is located between the top base and the bottom base and engages one end of the plunger.

14. A method of using a knife comprising a handle, a blade coupled to the handle; and a sharpening apparatus detachably coupled to the handle, the method comprising:
holding the knife;
separating the sharpening apparatus from the handle; and
sharpening the blade with the sharpening apparatus.

15. The method of claim 14, further comprising:
pushing the sharpening apparatus inward to release the sharpening apparatus from the handle of the knife.

16. The method of claim 15 further comprising: pushing the sharpening apparatus inward to secure the sharpening apparatus to the handle of the knife.

17. A method of making a knife comprising a handle, a blade coupled to the handle; and a sharpening apparatus within the handle, the method comprising:
creating the sharpening apparatus; and
inserting the sharpening apparatus into the handle.

18. The method of claim 17, further comprising:
obtaining a bottom base, a plunger, a spring, a top base, a holder, and a sharpening element;
connecting the sharpening element to the holder and inserting the sharpening element and the holder in a housing to form the sharpening apparatus;
assembling the top base and the bottom base such that the spring and at least a portion of the plunger are between the top base and the bottom base, and a portion of the plunger extends beyond the top base; and
coupling hollowed handle portions of the handle and enclosing the assembled top base and bottom base as well as the slot lining in a hollowed area of the handle formed by the hollowed portions.

19. The method of claim 18, wherein the holder comprises an elongated portion with stand portions which secure the sharpening element within the sharpening apparatus.

20. The method of claim 19, wherein the blade sharpening element comprises a sharpening wheel and the housing comprises slots for the blade to access the sharpening wheel during sharpening.
